(19) United States
(12) Patent Application Publication
(10) Pub. No.: US 2025/0355661 A1
(43) Pub. Date: Nov. 20, 2025

(54) EFFICIENT UPDATING OF SOFTWARE OF A MULTIPLICITY OF LOW-VOLTAGE ELEMENTS THAT ARE ABLE TO COMMUNICATE

(71) Applicant: Siemens Aktiengesellschaft, München (DE)

(72) Inventors: Eduard Bechtold, Poppenricht (DE); Maik Gruhle, Nürnberg (DE); Michael Decker, Nürnberg (DE); Gerd Müller, Falkensee (DE)

(21) Appl. No.: 18/871,292

(22) PCT Filed: Jun. 1, 2023
(86) PCT No.: PCT/EP2023/064744

§ 371 Date: Dec. 3, 2024

(30) Foreign Application Priority Data
Jun. 3, 2022 (DE) 10 2022 205 707.4

(51) Int. Cl. G06F 8/65; G06F 11/07; G06F 11/14

(52) U.S. Cl. CPC G06F 8/65; G06F 11/0784; G06F 11/1433

(57) ABSTRACT

A method for updating the software of a multiplicity of low-voltage elements that are able to communicate, includes arranging the low-voltage elements in groups and updated the individual groups of low-voltage elements succession. In contrast, the low-voltage elements in a group are updated substantially at the same time. This makes it possible to update the software of a networked system of low-voltage components more efficiently and more quickly. A control device and a system are also provided.

The invention relates to a method, a control device and a system for updating the software of a multiplicity of low-voltage elements that are able to communicate.

Low-voltage engineering involves a wide variety of circuit-breakers, which assume different protective functions. Common examples are earth-leakage circuit-breakers (also described as RCDs, or residual current devices), line circuit-breakers (also described as MCBs, or miniature circuit-breakers) and arc fault circuit-breakers (also described as AFDDs, or arc fault detection devices). Different functions can also be embodied in one breaker, c.f. DE 10 2010 021 068 A1 (AFDD+MCB), DE 10 2016 223 264 A1 (AFDD+RCD) and DE 10 2016 218 960 A1 (AFDD+RCBO, wherein a RCBO (Residual current-operated Circuit-breaker with Overcurrent protection) combines the functions of a RCD and a MCB). The latest developments are oriented towards semiconductor-based circuit-breakers. These are subsumed under the term “SSCB” (solid state circuit-breaker) and, in principle, can assume circuit-breaker functions in a selective manner, according to the software executed.

In general, a multiplicity of circuit-breakers are employed in combination. In many cases, breakers are arranged together in a switch cabinet. Mounting rails or top-hat rails are customarily employed for this assembly, to which the breakers are fitted and latched by means of a clamping mechanism.

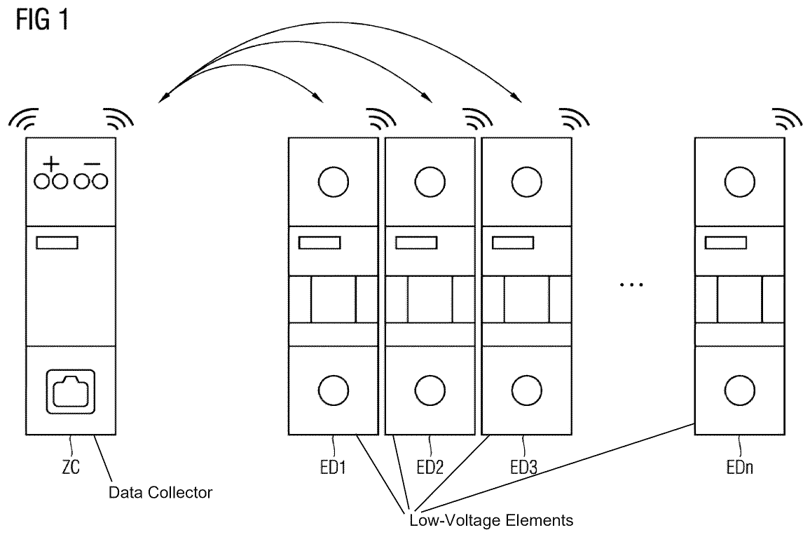

In recent years, circuit-breakers have increasingly been equipped with interfaces for wireless communication. FIG. 1 illustrates how a plurality of low-voltage elements (e.g. low-voltage protective devices or circuit-breakers) ED1, ED2, ED3, . . . . EDn are wirelessly connected to a data collector or data concentrator ZC. Communication is executed using the Zigbee protocol. By means of the data collector ZC, data for applications can then be transmitted directly or indirectly to the cloud. By means of the data concentrator ZC, the supply of data to the cloud can also be configured flexibly, e.g. with respect to settings, data adaptations and transmission options.

It is also possible that some of the low-voltage elements ED1, ED2, ED3, . . . . EDn are not independently able to communicate. These elements are then embodied by way of mechanical coupling with a communication module. A module of this type is described e.g. in DE 202021000293 U1.

Where a low-voltage element that is able to communicate is addressed hereinafter, a combination of a low-voltage element which is not independently able to communicate (in particular a low-voltage breaker, such as a RCD, or a MCB with no wireless communication interface) with a communication module of this type is also subsumed under the term “low-voltage elements that are able to communicate”.

The object of the invention is the improvement of the updating of software of a multiplicity of low-voltage elements.

This object is fulfilled by a method according to claim 1 a control device according to claim 9 or a system according to claim 10.

Advantageous further developments of the subject matter of the invention are disclosed in the subclaims.

A method is proposed for updating the software (e.g. firmware) of a multiplicity of low-voltage elements that are able to communicate (in particular circuit-breakers, smart fuses and measuring instruments). Low-voltage elements are arranged in groups, and these groups of low-voltage elements are updated sequentially. Conversely, the low-voltage elements of a group are not updated sequentially, but essentially simultaneously. The term “essentially simultaneously” signifies that the updating of individual low-voltage elements, in the interests of the most rapid possible updating, is executed in parallel. For technical reasons, it may not be possible for the updating of individual low-voltage elements to be simultaneous in its full scope. Accordingly, individual steps of the updating process can also be executed sequentially, e.g. in consideration of a resource-optimized downloading of software by a plurality of low-voltage elements from a single data concentrator. Overall, however, a temporal overlap of the updating of individual low-voltage elements is predominant, such that this updating of low-voltage elements in a group is described by the term “parallel” or “essentially simultaneous”. The term “updating” describes situations in which an equivalent software is transmitted to a plurality of end devices. This can also involve new software packages (e.g. the transmission of license files). If updating, in a stricter sense, describes a new version of a software which is already installed on the device, the term “update” is employed.

Exceptionally, a group of low-voltage elements can also comprise a single element only. The method is applicable, in the event that at least one group having more than one element is present. A check of the arrangement of low-voltage elements in groups can be executed to this effect. If no groups having multiple elements are present, a transition can then be executed to a consecutive updating of the individual low-voltage elements.

The term “multiplicity” signifies “three or more”. This definition is also logical with respect to technical instruction, in that the method can be executed with effect from a number of three low-voltage elements (two groups of low-voltage elements, one group having two elements, and one group having one element).

According to a further development of the method, a control device (which can also comprise a system of control devices) for controlling at least parts of the updating sequence communicates with the low-voltage elements (e.g. by means of a wireless protocol, such as Bluetooth, Zigbee, Thread, etc.). The low-voltage elements of at least a first group then transmit a status report to the control device, in the event that updating has been successfully executed, and the updating of a second group of low-voltage elements is commenced, if a status report has been transmitted to the control device by all the low-voltage elements in the first group which signals the successful execution of updating. Preferably, the low-voltage elements of all the groups transmit a status report to the control device and, in all groups, updating is only executed in the event that the all the low-voltage elements of the preceding group in the processing sequence have transmitted a status report to the control device which signals the successful execution of updating. The control device can also be, under some circumstances, a system comprising a plurality of physical devices which, in turn, preferably communicate with one another. An arrangement of this type is conceivable, if very large groups are involved (e.g. for the updating of all breakers in a large building or in a factory). According to a further development, low-voltage elements in the first group also transmit a status report to the control device, if it has not been possible to successfully execute updating. Any fruitless anticipation of a message concerning the completion of the updating of a low-voltage element can be prevented accordingly. In such a case, it is conceivable that the unsuccessful updating is retried and, in the event of success, that the updating of the next group is commenced. It is also possible that, exceptionally, the repetition of updating is executed in parallel with the updating of the next group. Potentially, updating of the second group commences as soon as status messages from all the low-voltage elements of the first group which are to be updated have been received, regardless of whether these messages indicate the successful completion or interruption of updating. This arrangement can be further refined, wherein it is required that a predetermined number, or a predetermined percentage or proportion of updates have been successfully completed, before the updating of the second group commences. If, for example, this criterion is not fulfilled, a further updating is attempted of those low-voltage elements in the first group, for which updating, in the first run, has not been correctly executed to its conclusion.

According to a further development of the configurations described in the preceding paragraph, in the event of the interruption of an update, the low-voltage elements generate an error report, by means of which the event can be identified, at the point of which the update has been interrupted. This error report, or information which is inferred therefrom (e.g. a percentage figure which is characteristic of the successful proportion of updating), together with a status report on the unsuccessful update, is then transmitted to the control device.

According to one configuration of the method according to the invention, it is provided that updating is initiated by an application of a device (desktop computer, laptop computer, mobile phone, etc.). For the initiation of updating, a message or command is transmitted to the control device. According to a further development, from the status reports for low-voltage elements in a group, a group status report is then generated and communicated by the control device to the application. In this manner, the application preferably receives consecutive group status reports for all the groups. In conjunction with the communication of group status, it is also possible to communicate the status of individual end devices. However, the application preferably has access to the group segmentation structure (which originates from the application, or has been communicated to the latter by the control device) and, by reference to successful group updates, can thus identify, and optionally display the individual updated end devices.

In the method according to the invention, the arrangement of low-voltage elements in groups is executed e.g. according to the type of low-voltage element (e.g. RCD, MCB, AFDD, smart fuse, measuring instrument, etc.) or according to the equivalence of software of the low-voltage elements (low-voltage elements having identical software are assigned to one group—in this case, it is conceivable that the control device of low-voltage elements retrieves an information report on software (potentially including the software version, if this is not already available). It can also occur that not all the low-voltage elements which fulfil the criterion for classification in one group are assigned to that group. This can be the case e.g. if a very large number of low-voltage elements of one type are present and, for reasons of efficiency, these are divided into two or more groups for the purposes of updating, i.e. only sub-quantities of low-voltage elements of one type are then updated simultaneously.

The invention further relates to a control device for controlling at least parts of a sequence for updating the software (e.g. firmware) of a multiplicity of low-voltage components that are able to communicate. This control device is configured to classify the low-voltage elements in groups, to support a consecutive updating of groups of low-voltage elements and, for an essentially simultaneous updating of low-voltage elements, to communicate with the latter in an essentially simultaneous manner. The control device can also be, under some circumstances, a system comprising a plurality of physical devices which, in turn, preferably communicate with one another. The control device can be part of a system which comprises a plurality of low-voltage elements or components having updatable software that are able to communicate and, potentially, an application that is configured to initiate an updating of the software of the plurality of low-voltage elements that are able to communicate. The arrangement of low-voltage elements in groups can be executed e.g. by the control device or by the application. In the first case, a system logic or rules for arrangement can be transmitted by the application to the control device and, in the second case, the arrangement can be communicated by the application to the control device.

The invention is described in greater detail hereinafter in the context of an exemplary embodiment, with reference to the figures. In the figures:

FIG. 1: shows a data collector and low-voltage protective devices which are wirelessly connected to one another;

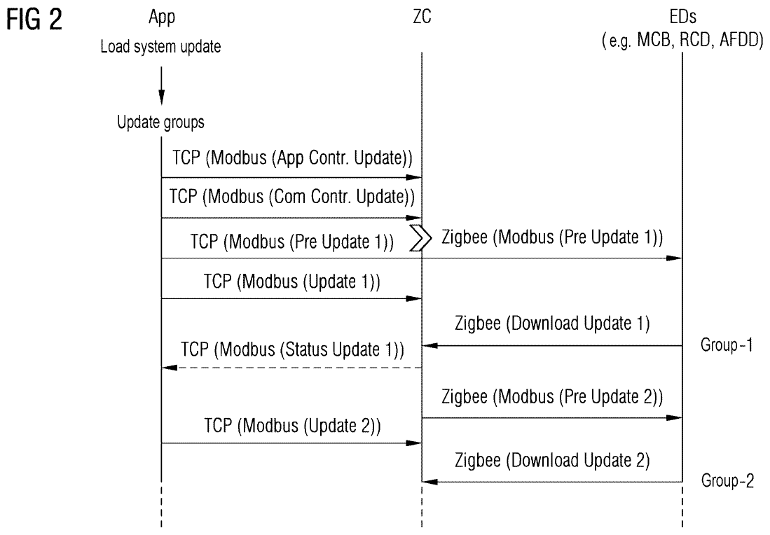

FIG. 2: shows a sequence diagram for an updating of low-voltage elements according to the invention;

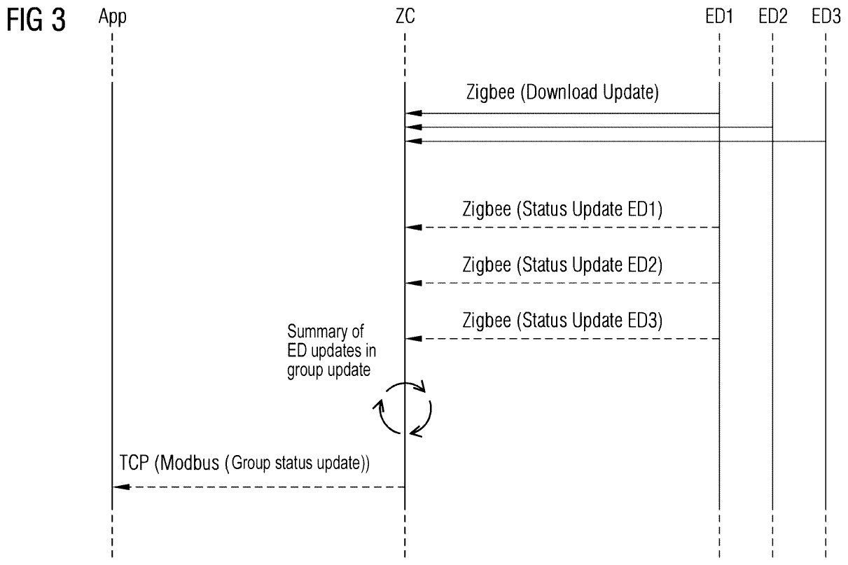

FIG. 3: shows a detailed section of an updating sequence according to FIG. 2; and

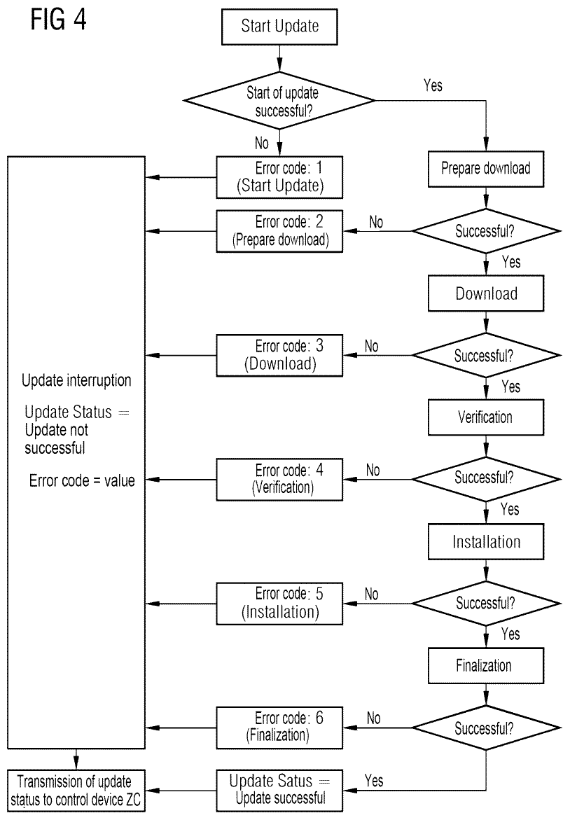

FIG. 4: shows a flow diagram for determining a status message for an updating of a low-voltage element, optionally in combination with a report as to which processing step has been interrupted.

FIG. 1 represents the wireless connection of a plurality of low-voltage elements (e.g. low-voltage protective devices or breakers) ED1, ED2, ED3 and EDn to a data collector or data concentrator ZC (ZC stands for Zigbee coordinator). Communication is executed by means of the Zigbee protocol. By means of the data collector ZC, data for applications can then be directly or indirectly transmitted to the cloud. By means of the data concentrator ZC, the provision of data in the cloud can be configured in a flexible manner, e.g. with respect to settings, data adaptations and transmission options. In the other direction, by means of the data concentrator ZC, settings in the low-voltage elements ED1, ED2, ED3 and EDn can be altered, software updated and tests initiated. In the context of the procedure according to the invention, this data concentrator ZC assumes control functions, and thus corresponds to a control device for employment, as described above, in configurations of the subject matter of the invention.

The procedure according to the invention for an arrangement corresponding to FIG. 1, i.e. a multiplicity of low-voltage elements which communicate via a data concentrator ZC, is described hereinafter. Communication via the data concentrator ZC is an optional configuration. In the specific exemplary embodiment represented, the data concentrator ZC is also employed for protocol adaptation. It is thus also conceivable for the method to be employed for a multiplicity of low-voltage elements which communicate in the absence of a data concentrator ZC. The low-voltage elements ED1, ED2, ED3, . . . . EDn according to FIG. 1 typically form a combination or a system wherein, for example, in their totality, they are responsible for power distribution and power protection functions within a specific scope. Hereinafter, the totality of these low-voltage elements is also described as a “system” or an “integrated system”.

FIG. 2 shows a sequence diagram in which an app, via a data concentrator ZC, executes a software update (hereinafter, the term “update” is subsumed under the term “updating”) on low-voltage elements EN which are configured as Zigbee end devices (abbreviated hereinafter to “end devices”—in the Zigbee protocol, this function is frequently designated by the acronym “ED” (for “end device”)). The app is e.g. the Powerconfig PC Windows application produced by the firm Siemens, and the data concentrator is the product marketed by the firm Siemens under the trade name “Powercenter 1000”.

For each app, an update package for the system can be downloaded and activated from the support portal of the manufacturer of end devices ED. The update package contains signed firmware images for all end devices in the integrated system, and thus ensures compatibility in the interaction of end devices. The app detects devices which are connected to a Zigbee coordinator (in FIG. 2, this is the data collector ZC) by reference to the MRPDs (machine-readable product designations) thereof. Identical device types, e.g. AFDDs, are divided into updating groups or update groups. The distribution logic is saved in the app. During the system update, the app firstly updates the Zigbee coordinator ZC in two steps, in each case by means of a file transfer using Modbus TCP for the “App Controller” and “Com Controller” programs (applications on Powercenter 1000). The first device group is then prepared for the update. Preparation of device groups for the update is respectively executed by means of a Modbus TCP command, which is relayed from the Zigbee coordinator ZC to the end devices. The Zigbee coordinator observes those end devices which, in the context of the update of the corresponding group, are intended to receive an update. The update is then relayed using Modbus TCP and an internal Modbus RTU communication from the app to the Zigbee coordinator ZC, and is buffered in the flash memory of the COM Controller. The update file in the Zigbee coordinator ZC is present in the standardized Zigbee OTA (over-the-air) file format and contains a proprietary update file in a signed proprietary format, which can only be downloaded by devices of the manufacturer. Immediately the update file is available, the previously instructed Zigbee end devices EN independently initiate a download. Further to the reception of the “Start FW Update” command, all the devices poll the Zigbee coordinator ZC until the latter, further to the reception of the “Start FW Update” command, feeds back to the effect that an appropriate update is available. The update process is terminated after a successful update, or further to a time-out. According to the invention, a parallel download is executed on equivalent device groups. As a result, the updating time is approximately halved (1 hour rather than 2 hours for 24 devices, e.g. AFDDs, or for “Zigbee Sleepy End Devices (Sleepy End Devices—SEDs—are a category of Zigbee end devices which assume a sleeping state for the reduction of energy consumption) and e.g. 2 hours rather than 4 hours for fuses having an instrument and communication function, which are marketed by Siemens AG under the designation “SENTRON 3NA COM LV HRC fuse link). The update status is supported by each individual end device ED, i.e. is notified to the Zigbee coordinator ZC and evaluated therein.

The procedure for the notification of update status is represented in greater detail in FIG. 3. This shows a section of an update of a group, e.g. of group 1 according to FIG. 2.

Three end devices ED1, ED2, ED3 are exemplarily represented. In practice, the number of update groups can be substantially variable. It is conceivable, for example, that an update group, under certain circumstances, comprises only one end device ED. According to a typical application, update groups are defined by the respectively equivalent low-voltage elements in a switch cabinet. However, it would also be conceivable for equivalent devices in an extensive installation (e.g. a building complex) to be updated in the context of a group update. In this case, the number of end devices ED might also lie within an order of magnitude of 10**2 to 10**3.

As represented in FIG. 3, further to downloading or the download, messages on the status of the update are transmitted by the individual end devices ED1, ED2 and ED3 to the Zigbee coordinator ZC. This message can comprise a confirmation of the successful software or firmware update. If the update has not been successful, an error message is transmitted to the Zigbee coordinator ZC. This error message can also contain information with respect to the phase in which the update has been interrupted, or the percentage of the update which has been completed (c.f. FIG. 4 and the description thereof).

FIG. 4 shows a flow diagram for the determination of an update message and, optionally, information for the more accurate location of the cause of an interruption. A distinction is drawn between the following phases: Start Update, Prepare Download, Download, Verification, Installation and Finalization. An error code is assigned to each of these phases, in the event of an interruption during the phase concerned. These codes are 1, if the update has failed to start altogether, 2 if the preparation of the download has not been successful, 3 if a problem occurs during the download of new firmware, 4 if authentication of the sender has not been successful, or the sender is not approved for a firmware update, 5 if a problem occurs during the installation of downloaded software, and 6 if the completion of the update is not successful. A percentage figure can be assigned to the error code, which represents a measure of the extent to which the update has progressed, prior to the occurrence of the error. The error code or percentage figure can then be transmitted, together with the error message, to the Zigbee coordinator ZC. Upon the successful completion of all phases, the Zigbee coordinator ZC receives a corresponding status message.

Progress on the Zigbee end devices EN1, EN2 and EN3 is totalized on the Zigbee coordinator ZC to form a group or gateway status (the term “gateway” refers to the control device and end devices EN which are connected by means thereof) and—as represented in FIG. 3—is notified to the app. If the update has been completed for one update group, the above-mentioned procedure is completed for the next group, until all the subordinate Zigbee end devices EN have been updated.

The app visualizes the status of the system update (i.e. progress in the update on individual groups), the individual group updates, and the update of the individual subordinate devices. The major advantage for the user is that only a single update procedure is required for the entire system, rather than up to 25 individual device updates. Manual procedures (initiation of updates, awaiting updates, compatibility controls for individual devices, etc.) are substantially reduced as a result.

1-11. (canceled)

12. A method for updating the software of a multiplicity of low-voltage elements being able to communicate, the method comprising:
arranging the low-voltage elements in groups;
sequentially updating the groups of low-voltage elements; and
substantially simultaneously updating the low-voltage elements in a group.

13. The method according to claim 12, which further comprises:
using a control device for controlling at least parts of the updating sequence to communicate with the low-voltage elements:
using the low-voltage elements of a first group to transmit a status report to the control device, in an event that updating has been successfully executed; and
commencing updating of a second group of low-voltage elements upon a status report being transmitted to the control device by all of the low-voltage elements in the first group, signaling a successful execution of updating.

14. The method according to claim 13, which further comprises using low-voltage elements in the first group to also transmit a status report to the control device, upon not having been possible to successfully execute updating.

15. The method according to claim 14, which further comprises:
using the low-voltage elements, in an event of an interruption of an update, to generate an error report, for identifying the event, at a point of interruption of the update; and
then transmitting the error report, or information inferred from the error report, together with a status report on the unsuccessful update, to the control device.

16. The method according to claim 13, which further comprises:
initiating updating by using an application of a device; and
transmitting a message to the control device for the initiation of updating by the application.

17. The method according to claim 16, which further comprises:
generating a group status report from the status reports of low-voltage elements of a group; and
using the control device to communicate the group status report to the application.

18. The method according to claim 12, which further comprises carrying out the arrangement of low-voltage elements in groups either according to a type of low-voltage element, or according to an equivalence of software of the low-voltage elements.

19. The method according to claim 12, which further comprises carrying out communication at least by a wireless protocol.

20. A control device for controlling at least parts of a sequence for updating the software of a multiplicity of low-voltage elements being able to communicate, the control device configured:
to classify the low-voltage elements in groups;
to support a consecutive updating of groups of low-voltage elements; and
to substantially simultaneous update low-voltage elements, to communicate with the control device in a substantially simultaneous manner.

21. A system, comprising:
a control device according to claim 20; and
a multiplicity of low-voltage elements having updatable software being able to communicate.

22. The system according to claim 21, which further comprises an end device having an application configured to initiate an updating of the software of the multiplicity of low-voltage elements being able to communicate.
